(19) United States
(12) Patent Application Publication
(10) Pub. No.: US 2012/0205933 A1
(43) Pub. Date: Aug. 16, 2012

(54) ROBOTIC HAND WITH PALM SECTION COMPRISING SEVERAL PARTS ABLE TO MOVE RELATIVE TO EACH OTHER

(75) Inventor: Jian Sheng DAI, London (GB)

(73) Assignee: King's College London, London (GB)

(21) Appl. No.: 13/457,950

(22) Filed: Apr. 27, 2012

Related U.S. Application Data
(63) Continuation of application No. 11/587,766, filed on Jul. 6, 2007, now abandoned.

(30) Foreign Application Priority Data
Apr. 29, 2004 (GB) 04 095 48.5

(51) Int. Cl. B25J 15/12

(52) U.S. Cl. 294/213

(57) ABSTRACT

An improved robotic hand in which the palm section enables it to be capable of a wide range of movement with the ability to have good precision and control. The palm section consists of a plurality of parts which are able to move or flex relative to each other. Preferably, it is constructed as five bar spherical linkage having two degrees of freedom.

### RELATED DOCUMENTS AND PRIORITY

This non-provisional Patent Application is a continuation application of currently pending U.S. patent application Ser. No. 11/587,766, filed Jul. 6, 2007, and claiming priority from PCT Patent Application PCT/GB2005/001665, filed Apr. 29, 2005, which claimed priority from UK Patent Application No. 04 095 48.5, filed Apr. 29, 2004, all disclosures of which are incorporated by reference herein in their entirety.

### BACKGROUND

The present invention relates to a metamorphic robotic hand that closely resembles the function of a human hand. In particular, the robotic hand includes highly reliable yet simple components which enable the desired movement and function of a plurality of flexible fingers attached to a metamorphic palm housing. The hand can also be used in an ambulatory mode to travel over surfaces.

The dexterity of the human hand enables it to execute complex and agile movements. Simulated movement of the human hand thus desirably achieves movement in directions having degrees of freedom similar to those in the human hand. Robotic simulation of movement in the human hand is practically limited by the size and weight of the components needed to simulate movement. The size of a robotic hand has conventionally suffered at the expense of obtaining the desired motion, and the desired dexterity of fingers and a thumb are achieved in a complex mechanism which still has limited capabilities. The action of these components does not closely approximate the desired movement of a human hand, and thus control of the robotic hand by a “smart glove” is less accurate.

Robotic hands tend to fall into one of two categories: they are either of the anthropomorphic type referred to above which was developed for orthopaedic use but have only limited application for other uses as they are bulky and complex to use and operate; or mechanical hands similar to industrial grippers which are widely used in industrial applications but have a limited range of movement and lack flexibility.

Robotic devices simulating movement of the human hand frequently tend to sacrifice one or more desired simulated functions for other desired simulated functions. Many robotic hand devices focus on simulating the overall appearance and movement of the human hand while neglecting other equally important features such as the size, weight, mobility and control of the robotic device. Conventional robotic devices are therefore relatively complex, large, cumbersome and difficult to use. The complexity of conventional robotic devices has also resulted in robotic hands which are expensive to manufacture and are also expensive to maintain. U.S. Pat. Nos. 4,986,723, 5,447,403 and 6,244,644 describe types of robotic hands.

In previous anthropomorphic robotic hands there are fingers attached to a palm and the fingers have joints in them; there is usually an opposed thumb or finger so the fingers can move in simulation of the human hand and grip and lift articles. The palm serves as the base for the fingers and performs no other functional operations.

In existing robotic hands there is a trade off between degrees of freedom and precision of movement. For range of movement and for complex manoeuvres two or more degrees of freedom give better results but for precision of movement and greater control one degree of movement gives better results.

### SUMMARY

We have now devised an improved robotic hand in which the palm can move independently of the fingers and in which the degrees of freedom can be changed.

According to the invention there is provided a robotic hand which comprises a palm section and a plurality of flexible fingers movably attached to the palm section in which parts of the palm section are able to move or flex relative to each other.

Preferably the palm section is able to move or flex about a central position.

This structure enables the fingers to move about a central position of the palm section without moving any finger joint. This enables the palm to contribute to the gripping of an object with the fingers.

By “central position” is not meant the exact central point but a location within the palm section: it would normally be in the vicinity of geometric centre.

Preferably the palm section comprises a plurality of hingedly connected bars and more preferably the palm section can be constructed as a network of curved bars hingedly connected together with the fingers mounted on the bars; the bars preferably form part of spherical sections.

The bars can be locked in position in any configuration so that the range of movement can be restricted. When two or more degrees of freedom are required the bars are all free to move independently about their hinged joints; when the degrees of freedom are to be reduced for greater control or precision of movement adjacent bars can be locked together thus reducing the degrees of freedom.

This locking of the bars together can be carried out when the bars are in any relative orientation to each other and two or more bars can be locked together.

In a preferred construction the palm section comprises five bars connected together at joints and this enables the structure to have two degrees of freedom. An analysis of the degrees of freedom of such structures is given in the Article “Mobility In Metamorphic Mechanisms Of Foldable/Erectable Kinds”, Journal of Mechanical Design Transaction of ASME, vol. 12, 1999, pp 375-382.

Preferably there is a finger attached to each bar so the fingers can move with the bars and optionally each finger can be locked in position on a bar.

Preferably there are five bars connected together and there are five fingers and preferably there are one or two fingers opposed to the other fingers to facilitate the gripping of objects.

Alternatively, there are three fingers attached to the longest bar, and the two adjacent bars and the longest bar comprise a fixing link. In one embodiment one bar covers substantially 180 degrees or more of the palm e.g. up to 210 degrees of the palm and two or more fingers are attached to this bar and act in opposition to a single finger on another section; this is analogous to the operation of a thumb and fingers in a human hand.

Preferably each finger includes a plurality of hingedly connected segments with at least one segment of each finger operatively connected to another segment of the same finger. Typically the fingers have three segments like a human finger and they can be operated by drive motors and electronics which enable the controlled movement of the fingers.

In one embodiment of the invention each of the fingers can be operated by a pulley mechanism in which two cables are attached to a segment, preferably the end segment of the finger, and the cables pass over a pulley arrangement to a motor. When one cable is tightened the segment moves in one direction and when the other cable is tightened the segment moves in the other direction. The cables operate cooperatively analogous to the operation of muscles and tendons in a human finger or hand. There can be one pair of cables per segment or one pair of cables per finger depending on the application. The motors which can be used include analogue motors, stepper motors etc. The motors can be mounted in a suitable container attached to the device with their own power supply such as batteries or by cable to a power source.

In order to move the palm section of the device there is preferably a motor attached to at least one of the joints between two of the bars so that operation of the motors moves the bars relative to each other and so cause the palm to flex.

The hand preferably includes one or more fingers primarily used for manipulation of an object and one or more grasping fingers primarily used to maintain a stable grasp on the object. The fingers can functionally resemble the fingers on the human hand. A segment sensor may be attached to each of the hingedly connected segments on a respective finger to sense the relative position of that finger segment as it bends relative to the palm housing.

A shock absorber can be positioned between the palm and a respective finger for mitigating stress transferred to the finger when jarred towards the palm housing, either while the finger is in an opened (extended or straight) position or while the finger is in a closed (bent or grasping) position.

The components of the device can be from a metal such as aluminium or a rigid plastics material or composite. The shape of the segments is not critical but preferably each segment has an elliptical cross section.

It is a feature of the invention that the metamorphic palm of the robotic hand can be changed from one with two degrees of freedom to one with one degree of freedom so that a combination of flexibility with precision and accuracy can be obtained. In addition or alternatively the palm can be further changed to one with zero degree of freedom so that the palm becomes a rigid structure; this can be achieved either by overlapping and locking two bars as in changing from a palm with two degrees of freedom to one with one degree of freedom. The other is to use a revolute-locking joint which can lock two adjacent bars when a certain degree of revolution is reached.

The device can be used to exert considerable gripping force by using suitably powerful motors and this force can greatly exceed that which can be exerted by the average human hand. There can be sensors attached to the gripping ends of the fingers so that the amount of pressure being exerted can be monitored and controlled; this is important when handling fragile or delicate objects. The motors can have different power so that large powerful movements are controlled by e.g. the motors controlling the operation of the palm section and smaller, more sensitive movements are controlled by the motors controlling the fingers.

In a preferred embodiment of the invention the motors used to operate the fingers and the sections of the bars are controlled by a microprocessor which can be linked by cable or electronically to a controller e.g. as part of a computer. In this way an operator can control the operation of the device. It is possible that the control mechanism can be operated by means of sensors attached to a human hand so that, as the fingers and palm of the hand are moved, the finger and palm of the device moves correspondingly.

The very wide range of movements possible with the device enables objects of a very wide range of sizes and dimensions to be grasped and manipulated and the device can replace the operation of a human hand in a vast range of operations, including in remote and inaccessible locations.

The device can also be used to replace human operations such as in agriculture, for example fruit picking, harvesting etc.

The device of the present invention can also be used in an ambulatory mode i.e. it can travel over surfaces. When the device is being used in an ambulatory mode each of the “fingers” can be in contact with the ground with the “palm” positioned above them; each of the fingers can act independently of the others with the fingers moving together or in sequence to give a smoother motion. There can be any structure or attachment attached to the device such as a platform or robot etc. The range of movement possible with the device of the present invention enables such a device to proceed over a range of surfaces which are uneven and at different levels as well as carry out movements such as climbing stairs etc. with much less tilting or swaying. This has hitherto been a problem with robots due to the limited range of movement inherent with present robot structures.

The applications of the device of the invention particularly include working in hazardous or environmentally dangerous conditions such as in areas exposed to high levels of radiation, or where there are pathogens such as bacteria and viruses e.g. in research facilities or in contaminated areas. The device can also be used in search and rescue operations in dangerous structures such as buildings which are in danger of collapsing e.g. after an earthquake or when there is the presence or danger of fire. The device can also be used in space operations or in operations on other planets where the need to move over a very varied range of surfaces is essential. In such operations two or more devices can be connected together, with one device being used in an ambulatory mode and the other device being used for picking up objects and for manipulation of objects etc. Also the device can be used as an excavator for example in the five bar embodiment the pose of three grippers can be adjusted via the change of the 5-bar linkages to adapt to different materials, e.g., logs, stones, steels, flour sacks. etc. Other applications are in military operations, e.g. for mine removals and for dismantling dangerous devices.

### DESCRIPTION OF FIGURES

The invention is illustrated in the accompanying drawings in which

FIG. 1 is a schematic view of the linkages forming the palm section

FIG. 2 is a schematic view of a different configuration of the palm section

FIGS. 3a and 3b are diagrammatic representations of the orientation of the bars

FIG. 4 shows a hand with the palm in the open position

FIG. 5 shows a hand with the palm in the closed position and

FIG. 6 shows a revolute-locking joint.

### DETAILED DESCRIPTION

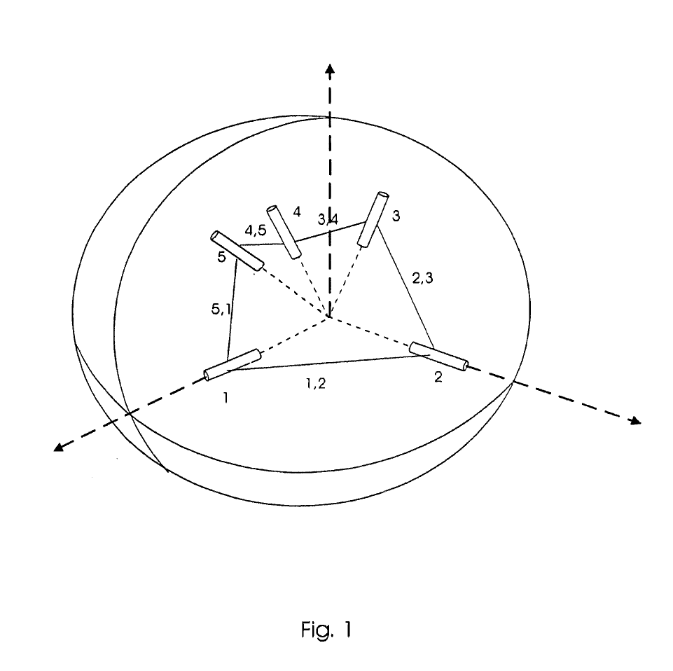

Referring to FIG. 1 the palm section is formed of five curved bars (1, 2); (2, 3); (3, 4), (4, 5) and (5, 1) hingedly connected at joints (1), (2), (3), (4) and (5). The palm section acts as a five bar spherical linkage and has two degrees of freedom.

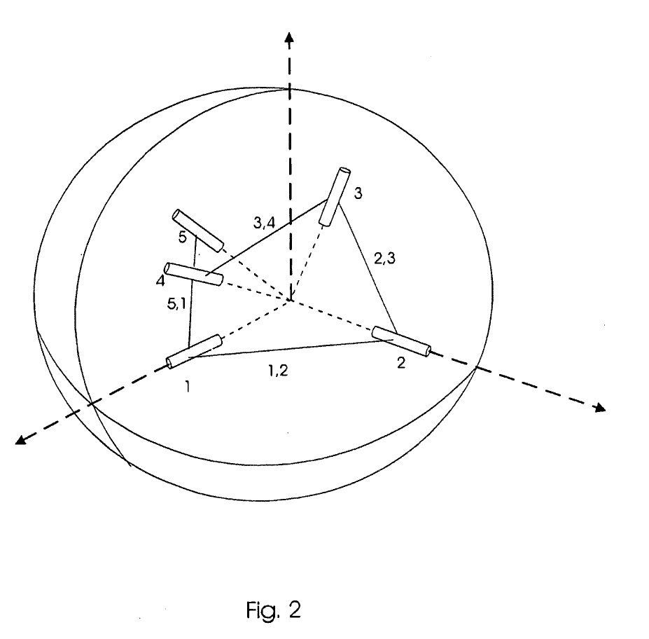

The configuration can be changed by movement about the joints, for example, referring to FIG. 2 a new configuration is reached when the joint (4) moves to its limit so that the bar (4, 5) overlaps the bar (5, 1), the bars (4, 5) and (5, 1) can be attached or can be self attaching to form one link so that the structure is a four-bar spherical linkage.

The joints (1), (2), (3), (4) and (5) can be locked so that the degrees of freedom are reduced.

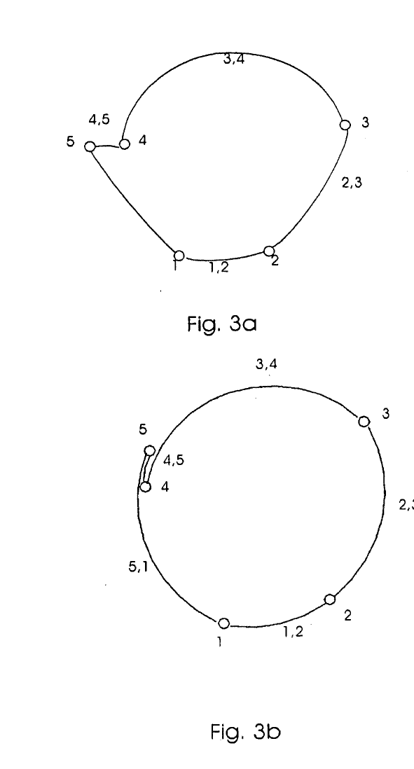

Referring to FIG. 3a this shows a structure with different lengths of the linking bars and FIG. 3b shows an opposed view of the structure.

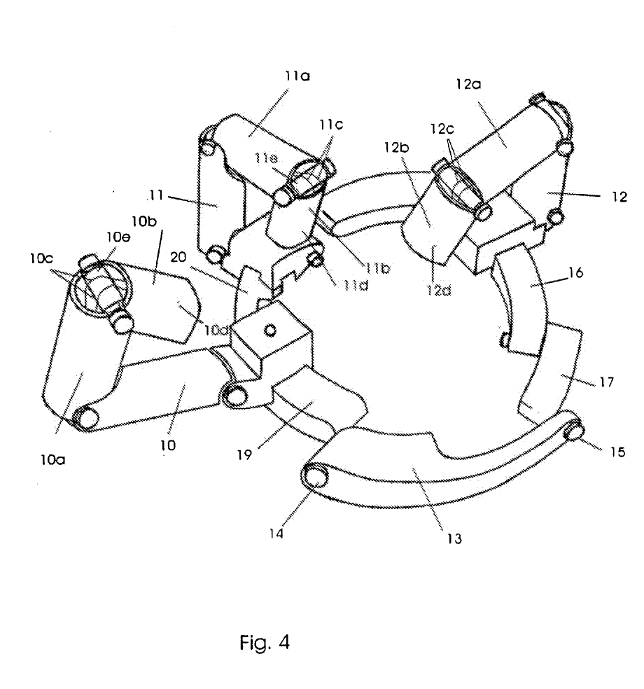

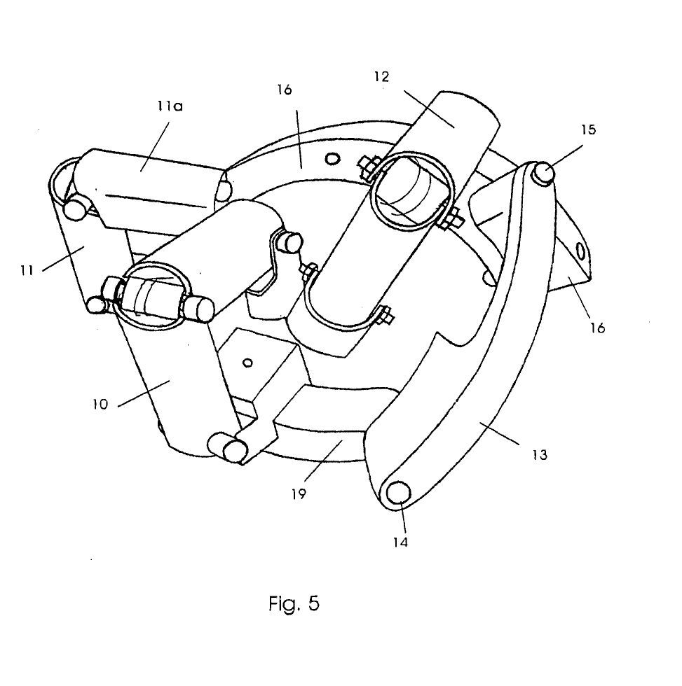

Referring to FIGS. 4 and 5, the palm consists of five metal bars (16), (17), (13), (19) and (20) hingedly connected to each other and the hinges (14), (15) and (17) are shown. There are three fingers (10), (11) and (12) with hinged segments (10a), (10b); (11a), (11b) and (12a), (12b) mounted on bars (19), (20) and (16) respectively. The finger segments can move relative to each other to grip objects etc. The movement of the finger segments are operated by means of pairs of cables (10c), (11c) and (12c) which pass over a pulley as shown. One end of each cable is attached to the end linger segment with one cable being attached at (10d), (11d) and (12d) respectively and the other cable attached to a point opposite (not shown). In each finger one cable is attached to one side of the end segment and the other cable is attached to the opposite side. In practice the cables each pass around the pulley at least once for operational reasons. Similar pulley and cable arrangements operate on each of the joints between the segments, so that pulling on one cable moves the finger in one direction and pulling on the other cable moves the finger in the opposite direction.

The connections (14), (15) are sunk pins for ease of operation.

To go from the open position to the closed position the bars move about the hinged joints to go from the open orientation of FIG. 4 where the palm has two degrees of freedom to the closed orientation of FIG. 5, where the bars can be locked in position and the palm has one degree of freedom. The fingers can be used to manipulate objects etc. held in the palm.

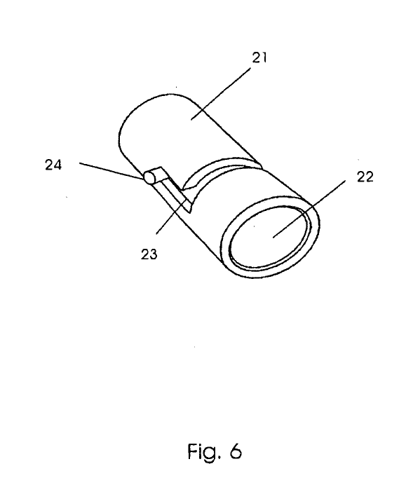

Referring to FIG. 6 a revolute-joint for locking the ends of two adjacent bars (21) and (22) together when going from a palm with one degree of freedom to a palm with zero degrees of freedom comprises a slot (23) in one bar and a pin (24) in the other. As can be seen, when the pin (24) is in the position shown the two bars are locked together and when the pin is in a different location in the slot there is freedom of movement between the bars. The bars are locked when a certain degree of revolution between the bars is reached.

What is claimed is:

1. A robotic hand which comprises a palm section and a plurality of flexible fingers movably attached to a palm section in which parts of the palm section are able to move or flex relative to each other.

2. A robotic hand as claimed in claim 1, in which the palm section is able to flex or move about a central position.

3. A robotic hand as claimed in claim 1, in which the fingers comprise a plurality of segments hingedly connected together.

4. A robotic hand as claimed in claim 3, in which there are three segments.

5. A robotic hand as claimed in claim 1, in which the fingers can move about a central position of the palm section without moving any finger joint.

6. A robotic hand as claimed in claim 1, in which the palm section comprises a plurality of hingedly connected bars.

7. A robotic hand as claimed in claim 6, in which the bars form part of the spherical sections.

8. A robotic hand as claimed in claim 6, in which the palm section is constructed as a network of curved bars hingedly connected together with the fingers mounted on the bars.

9. A robotic hand as claimed in claim 6, in which the bars can be locked in a position relative to each other.

10. A robotic hand as claimed in claim 1 in which the palm section can be locked in a fixed position by a locking mechanism.

11. A robotic hand as claimed in claim 10, in which the palm section can change from having two degrees of freedom to having one degree of freedom by operation of the locking mechanism.

12. A robotic hand as claimed in claim 10, in which the palm section can change from having one degree of freedom to having zero degrees of freedom by operation of the locking mechanism.

13. A robotic hand as claimed in claim 1, in which the palm section is constructed as a network of five curved bars hingedly connected together and there are fingers attached to three of the five bars of the palm, with the longest bar as a fixing link and the fingers are attached to the longest bar and adjacent to two bars.

14. A robotic hand as claimed in claim 1, in which the fingers are installed such that three fingers can grasp an object to form a force closure such that a complete constraint is applied to a grasped object.

15. A robotic hand as claimed in any of the preceding claim 1, in which the fingers comprise a plurality of segments and at least one segment of each finger in connected to a pair of cables with the cables being attached to opposite sides of the segment, so that. when one cable is pulled the segment moves in one direction and when the other cable is pulled the segment moves in the opposite direction.

16. A robotic hand as claimed in claim 15, in which there is one pair of cables per segment.

17. A robotic hand as claimed in claim 15, in which there is one pair of cables per finger attached to the end segment.

18. A robotic hand as claimed in claim 1, in which there are motors which operate the movement of the fingers and the palm.

19. A robotic hand as claimed in claim 18 in which the motors are mounted in a container attached to the device.

20. A robotic hand as claimed in claim 1, in which the fingers and the sections of the bars are controlled by a microprocessor which is lined to a controller.

21. A robotic hand as claimed in claim 1, adapted to be used in a ambulatory mode.
